(19) United States
(12) Patent Application Publication
(10) Pub. No.: US 2019/0134768 A1
(43) Pub. Date: May 9, 2019

(54) METHOD AND APPARATUS FOR WATER JET CUTTING STANDOFF HEIGHT

(71) Applicant: Kiffer Industries, Inc., Cleveland, OH (US)

(72) Inventor: Dale Phillip, Cleveland, OH (US)

(21) Appl. No.: 16/179,144

(22) Filed: Nov. 2, 2018

Related U.S. Application Data
(60) Provisional application No. 62/581,739, filed on Nov. 5, 2017.

(51) Int. Cl. B23Q 17/24; B23Q 17/20; B23Q 17/22; B23Q 23/00; B26F 3/00

(52) U.S. Cl. CPC B23Q 17/2414; B23Q 17/20; B23Q 17/2233; B26F 3/004; B23Q 17/2471; B23Q 23/00; B23Q 17/2447

(57) ABSTRACT

A water jet material cutting system includes a table configured to receive work piece. The cutting system further includes a bevel head for cutting the work piece. A positioning apparatus controls the relative position and orientation of the bevel head with respect to the work piece. A controller is configured to control the positioning apparatus. A height sensor attached to the positioning apparatus determines a standoff height of the bevel head relative to the work piece.

### CROSS-REFERENCE TO RELATED APPLICATIONS

This application claims priority to U.S. Provisional Patent Application Ser. No. 62/581,739 filed Nov. 5, 2017, and entitled METHOD AND APPARATUS FOR WATER JET CUTTING STANDOFF HEIGHT, which is herein incorporated by reference in its entirety.

### BACKGROUND

### Field of the Disclosure

This application relates generally to material cutting machines and, in particular, relates to a method and apparatus for determining standoff height on a water jet cutting device.

### Description of Related Art

Material cutting systems such as water jet cutting systems are widely used for cutting materials and can be employed in automated systems for automatically processing a work piece. Many known water jet cutting systems do not verify a standoff height of a focus tube from the work piece when the focus tube is positioned at an angle from the perpendicular, particularly during a bevel cutting operation. This lack of standoff height verification can cause an actual cut path to diverge from a desired cut path because surface height variations in the work piece affect the geometric relationship between the focus tube and the work piece. Other known water jet cutting systems employ standoff height verification, but the devices are located a relatively long distance from the focus tube water jet, thus a) decreasing the accuracy of the measurement and/or b) requiring a relatively long stroke of the verification device due to the angle of the bevel head. Furthermore, other measurement systems such as laser measurement can be ineffective when used in conjunction with a water jet cutting system. Therefore, there is a need to provide an improved standoff height detection apparatus for a water jet cutting system that enables the operator or a CNC system to better control the standoff height of the focus tube and the water jet to compensate for work piece surface height variations. The standoff height detection apparatus is configured to work when the focus tube is positioned at an angle from the perpendicular, or when the focus tube is positioned on the perpendicular.

### BRIEF DESCRIPTION OF THE DRAWINGS

The structure, operation, and advantages of the presently disclosed embodiment of the disclosure will become apparent when consideration of the following description taken in conjunction with the accompanying drawings wherein:

FIG. 1 is a perspective view of a water jet material cutting system in accordance with an exemplary embodiment of the disclosure;

FIG. 2 is an enlarged perspective view of a portion of the water jet material cutting system of FIG. 1;

FIG. 3 is an enlarged perspective view of a portion of the water jet material cutting system of FIG. 1;

FIG. 4 is a schematic representation of a table stored within a control station of the water jet material cutting system of FIG. 1;

FIG. 5 is a detail perspective view of a focus tube and a probe head of the height sensor of the water jet material cutting system of FIG. 1;

FIG. 5A is a cross-section view of the focus tube and probe head taken along line 5A-5A of FIG. 5;

FIG. 6 is a perspective view of the cutting system of FIG. 1 cutting a work piece showing the offset in location of an actual cutting path from an intended cutting path due to surface height variation of the work piece;

FIG. 7 is a top view of a work piece that may be cut on the water jet cutting system of FIG. 1 showing the offset in location of an actual cutting path from an intended cutting path due to surface height variations in the work piece without standoff height control;

FIG. 8 is a cross-section view similar to FIG. 5A showing a concave shape of the underside of the probe head;

FIG. 9 is a top level flow diagram of a method of operating a water jet material cutting system of FIG. 1 in accordance with an aspect of the present disclosure; and

FIG. 10 shows four touch points during a calibration process for moving the focus tube to an orientation perpendicular to the work piece.

Corresponding reference characters indicate corresponding parts throughout the views of the drawings.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements.

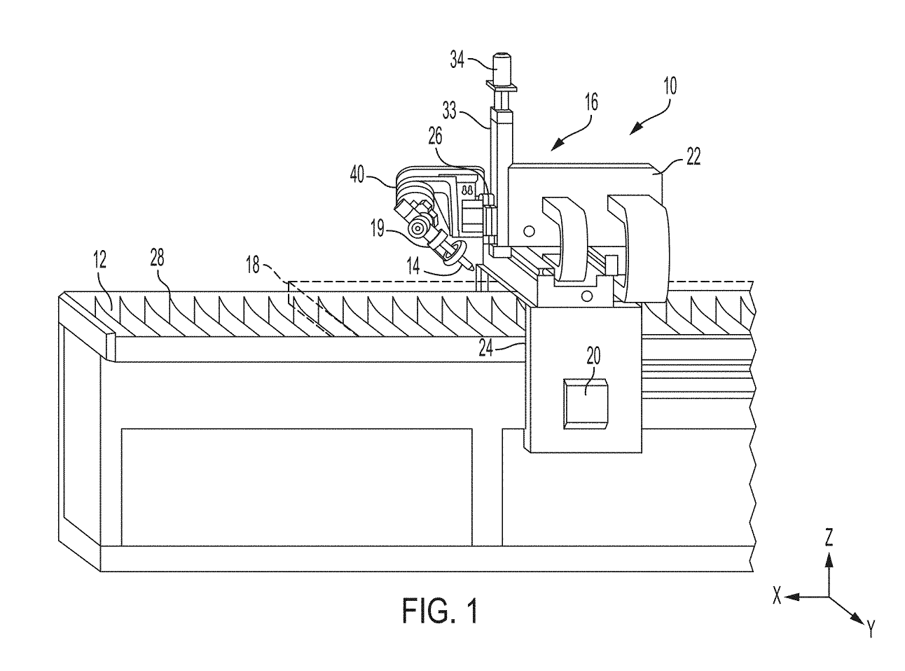

Referring now to the drawings, FIG. 1 illustrates a water jet material cutting system 10 in accordance with an exemplary embodiment of the present disclosure. The system 10 includes a generally planar table 12 for receiving a work piece 18, a focus tube 14, and a positioning apparatus 16 for controlling the position and orientation of the focus tube 14 with respect to the work piece 18 on the table 12. The focus tube 14 is attached to a bevel head 40. The focus tube 14 may be of any suitable conventional or special design.

Although a detailed illustration of the focus tube 14 is omitted herein, it should be noted that water jet focus tubes use a stream of fluid issued at high pressure and velocity to cut a stock material. The stream of fluid may include a suspended abrasive material (e.g., garnet) to aid the cutting process. The focus tube 14 can comprise a carbide material and therefore can be susceptible to breakage. Focus tubes are well known in the industry and need not be described in further detail herein.

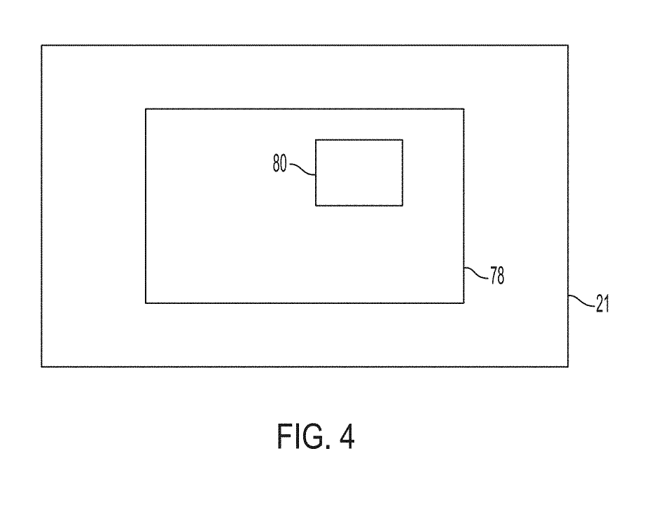

A control station which may be part of a Human-Machine Interface (HMI) is mounted adjacent the table 12 to provide the positioning apparatus 16 with position control. The control station contains a suitable computerized numeric controller (CNC) 21 (best seen schematically in FIG. 4).

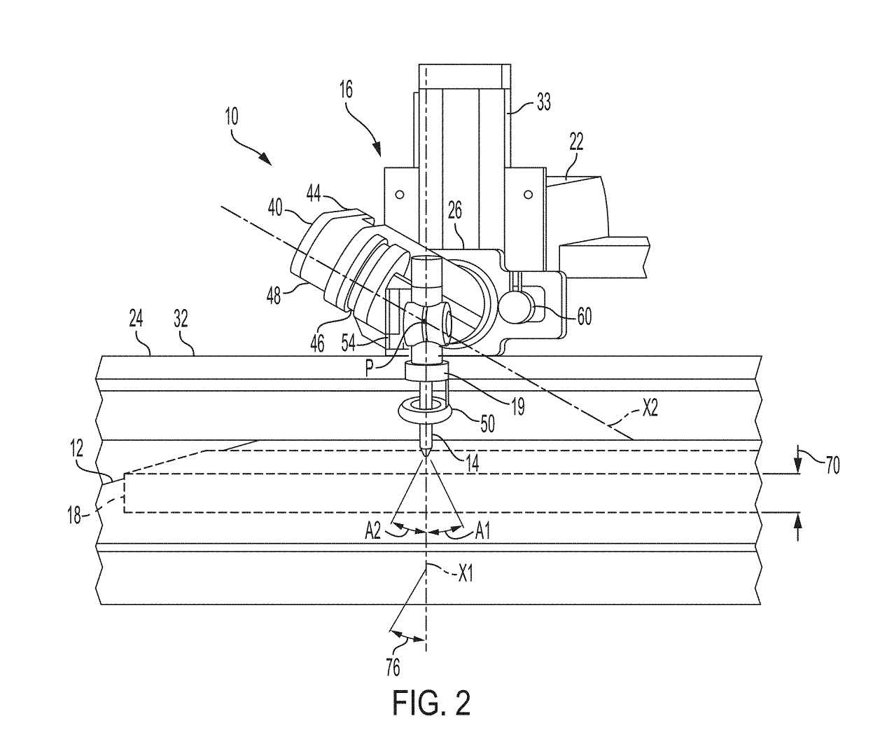

In one example, the positioning apparatus 16 has five degrees of freedom about which it can move the focus tube 14 relative the work piece 18. The positioning apparatus 16 includes an overlaying gantry 22 with a traveling beam 24 disposed so as to traverse the table 12. Disposed on the traveling beam 24 is a carriage 26 on which the focus tube 14 is mounted. The traveling beam 24 is movable by operation of an X-axis servomotor 20 in the direction of the X-axis along an X-axis rail 28, which extends in a longitudinal direction (i.e., the X-axis direction) of the table 12. Often, the traveling beam 24 is movable by two X-axis motors 20 located on either side of the table 12. The X-axis motors 20 are in electrical communication with each other to operate at the same time at the same speed. In another example, one of the X-axis motors 20 can be slaved to the other X-axis motor 20. The carriage 26 is movable by operation of a Y-axis motor (not shown) in the direction of the Y-axis along a Y-axis rail 32 (best seen in FIG. 2) disposed on the traveling beam 24. Movement of the carriage 26 can be effected by structure such as a servo (i.e., the Y-axis motor), a gear reducer, and a rack. The bevel head is movable by operation of mechanical slider 33 connected to a Z-axis motor 34 for movement in a vertical direction (i.e., the Z-axis direction) relative to the table 12. By controlling each motor, the focus tube 14 is moved to a desired position on the table 12 to cut the associated work piece 18.

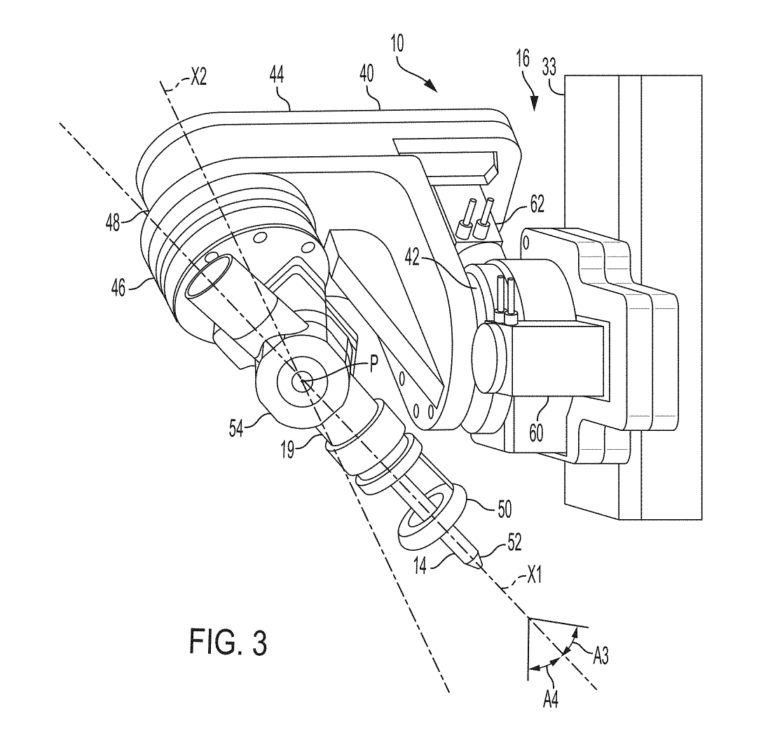

As can be better seen in FIGS. 2 and 3, a bevel head 40 is mounted to the carriage 26. The bevel head 40 and the focus tube 14 selectively rotate about two different axes so that the focus tube 14 can be tilted at an angle relative the mutually orthogonal X, Y, and Z-axes. The bevel head 40 contains a first pivot mount 42, a boom 44 extending from the first pivot mount 42, and a second pivot mount 46 on a distal end 48 of the boom 44. The pivot mounts 42, 46 can also be known as robot knuckles, gear reducers, rotary drives, etc.

A suitable first motor, such as a first servomotor 60 coupled to a timing belt and in-line gear reducer (not shown), selectively rotates the first pivot mount 42 for positioning the focus tube 14. In one example, the first servomotor 60 rotates the first pivot mount 42 about an axis parallel to the X-axis. The second pivot mount 46 with a second servomotor 62 selectively rotates the second pivot mount 46 for positioning of the focus tube 14. In another example, the second servomotor 62 rotates the second pivot mount 46 about an axis offset at a particular angle from the Z-axis. Accordingly, once an understanding of the positioning apparatus 16 is ascertained, it should be appreciated that the bevel head 40 and the focus tube 14 may be moved during a cutting operation to cut a wide variety of shapes in work piece 18, including circular, square, slotted and other shapes. In one example, the focus tube 14 may be positioned to compensate for the angle of the side of the kerf by providing a selected bevel cut where desired. Other means of compensating for the angle of the side of the kerf are also known and need not be described here.

A height sensor 501 is provided on the bevel head 40. The height sensor 501 can include various parts such as a probe head 50, a slide 502, a linear actuator 503, and an encoder 504. The linear actuator 503 can move the probe head 50 along with the moving part of the slide 502 to selectively move the probe head 50 along the X1 axis of the focus tube 14. The moving part of the slide can be attached to a bracket which is then, in turn, attached to the probe head 50. In one example, the linear actuator 503 can be an air cylinder.

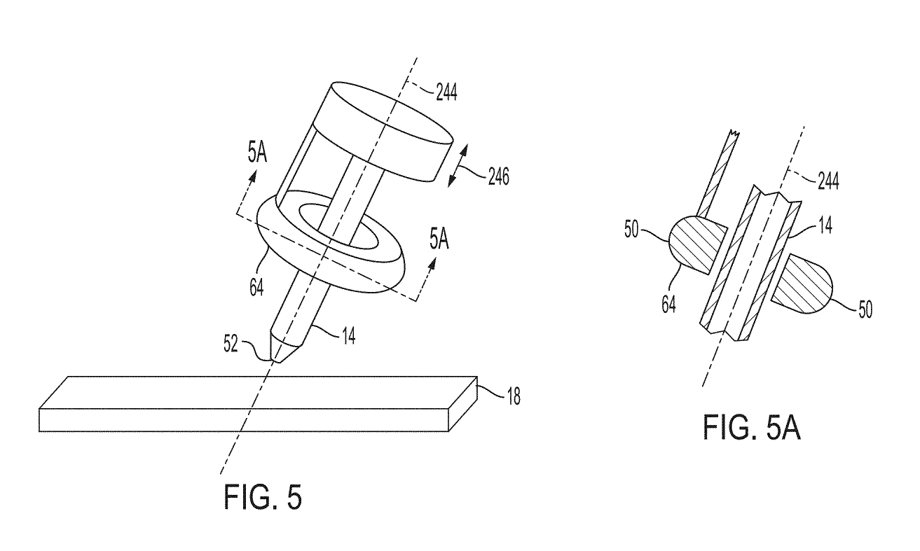

The focus tube 14 and the probe head 50 encircling the focus tube 14 are mounted on a tool holder 54 on the second pivot mount 46. Water jet supply lines (not shown) extend from a port (not shown) on the rear end of the focus tube 14. In one example, the probe head 50 is movable along the body of the focus tube 14 (i.e., parallel to axis X1). This movement of the probe head 50 enables the air cylinder to position the probe head 50 close to and contact the work piece 18. This is true even when the focus tube 14 is positioned at an angle such as for a beveled cut. Desirably, the probe head 50 does not touch the focus tube 14 such that an actuator (not shown) may be used to raise and lower the probe head 50 and not simultaneously cause damage to the focus tube 14. Additionally, a gap (best seen in FIG. 5A) between the probe head 50 and the focus tube 14 can limit and/or eliminate the possibility of damage to the focus tube 14 from movement of the probe head 50. In another example, a sheath may be placed between the focus tube 14 and the probe head 50. It may be advantageous to construct the devices that mount the probe head 50 to the bevel head from rigid materials in order to further lessen the possibility of damage to the focus tube 14. For example, more rigid mounting materials can limit and/or eliminate the movement or collision of the probe head 50 against the focus tube 14.

In operation, a user places the associated work piece 18 on the cutting table 12 and mounts the focus tube 14 on the positioning apparatus 16 to provide relative motion between the tip 52 of the focus tube 14 and the work piece 18 to direct the focus tube 14 and its water jet along a processing path. Typically, the user provides a start command to the CNC 21 to initiate the cutting process. The CNC 21 communicates with the positioning apparatus 16 to direct the motion of the bevel head 40 and the focus tube 14 to enable the work piece 18 to be cut to a desired pattern. The positioning apparatus 16 uses signals from the CNC 21 to direct the bevel head 40 and the focus tube 14 along a desired cutting path. Position information is returned from the positioning apparatus 16 to the CNC 21 to allow the CNC 21 to operate interactively with the positioning apparatus 16 to obtain an accurate cut path.

The air cylinder controls the height of the probe head 50 relative to the focus tube 14 by controlling the linear actuator 503. The linear actuator 503 moves the probe head 50 down to the surface of the work piece 18 where it makes contact with the work piece 18 and then stops. The probe head 50 is attached via linkage to the slide 502 and the linear encoder 504 and the linear actuator 503. Movement of the probe head 50 moves the linkage, which then enables the linear encoder 504 to recognize the distance moved by the probe head 50 until contact with the work piece 18. The encoder 504 can then communicate the distance moved by the probe head 50 to the CNC 21. The CNC 21 then compares the distance moved by the probe head 50 to a distance to the desired standoff height, for example, surface height variation may have changed by 0.020 inches. Then the CNC 21 operates a servo to move the bevel head 40 and the focus tube 14 that is mounted to the bevel head 40 up or down in the Z-axis to maintain the desired standoff height. Maintaining the desired standoff height can help ensure the desired cut dimensions are maintained despite potential surface height variations and also maintain a particular desired cut quality.

In one example, the application software contains a height controller that provides an optimum standoff height (distance) for the desired cutting process. The standoff height refers to the gap between the surface of the work piece 18 and the tip 52 of the focus tube 14. The height controller directs the probe head 50 driven by an actuator (not shown) that is distinctly separate from the actuator of the focus tube 14. An encoder provided inside the height sensor 501 is in electrical communication with the CNC 21. The encoder 504 provides location information from the probe head 50 back to the CNC 21. In one example, the probe head 50 may be lowered to touch the surface of the associated work piece 18 periodically during a cutting operation. Because the probe head 50 includes a surface 64 having a known radius and the surface faces the associated work piece, the CNC 21 can accurately calculate the standoff height of the focus tube 14 from a top surface of the work piece 18. If the Z-axis elevation of the bevel head 40 requires modification to maintain the standoff height, the CNC 21 can direct the actuator to move the bevel head 40 and the focus tube 14 to the desired standoff height. As noted previously, maintaining the desired standoff height helps ensure the cut lines of the work piece 18 have the desired dimensions.

The known radius of the surface 64 on the probe head 50 can have several forms. In one example, the known radius of the surface can be a spherical surface. In another example, the annular shape of the probe head 50 can include a circular radius around the end of the annular shape. Other forms are contemplated, and the form is not critical, so long as the CNC 21 can use the known radius to calculate the standoff height from the associated work piece 18.

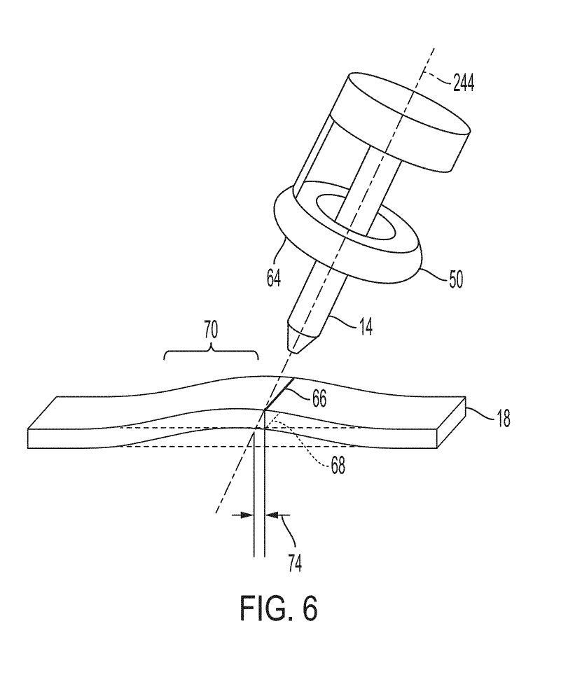

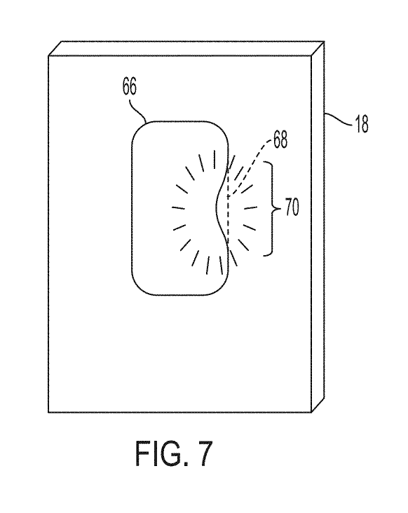

An accurate calculation of the standoff height can be useful to know. In one example, the surface of the work piece 18 may include surface height variations as shown in FIGS. 6-7. During a cutting operation, the probe head 50 can be lowered periodically to detect such surface height variations. If, for example, the work piece 18 includes a concave (relative to the table 12, i.e., bump facing upward) deformity as in FIG. 6, the CNC 21 can alter the standoff height to help ensure the desired cutting path is maintained. As can be appreciated, if the focus tube 14 is located at an angle to the work piece 18, changes in the standoff height will affect the geometry of the desired cut path. This is shown in FIGS. 6 and 7. The actual cut path (solid line 66) is altered from the desired cut path (dotted line 68) by surface height variations 70 in the work piece 18. IF there is no height control to maintain a uniform standoff height, the dimensions of the cut part change, even though the cut path has not changed. In order to maintain the desired dimensions of the cut lines, the CNC 21 activates the actuator to move the bevel head in the Z-axis to maintain the desired standoff height. Machines without the feature of standoff height control can experience significant changes in the dimensions of the resulting cut pattern (represented by dimension 74), particularly considering the relatively close tolerances to which water jet material cutting systems can operate.

Therefore, with the information of the changed standoff height, the CNC 21 can alter the standoff height to keep the actual cut path identical to the desired cut path to account for the changed geometry of the focus tube 14 and the work piece 18. In one example, the height sensor 50 is in electrical communication with a feedback card provided inside the control station to provide standoff height information to the CNC 21. The CNC 21 compares the standoff height information provided by the feedback card to a desired standoff height. If the standoff height information is not equal to the desired standoff height, the CNC 21 provides an input signal to the motor 34 to change the standoff height. Most often this is simply an adjustment of the bevel head on the Z-axis. The use of an encoder and a feedback card are known in the art and need not be discussed herein in further detail.

The described apparatus and procedure can accurately measure the standoff height while the focus tube 14 is positioned at a non-zero angle to the X1 axis or parallel to the X1 axis. In one example, the angle can be between 0° and about 45°. As such, the height sensor 501 enables the operator and/or the CNC 21 to determine the standoff height whether or not the focus tube 14 is perpendicular to the top surface of the work piece 18. In other words, the goal is to maintain a fixed standoff height to obtain the desired cut line even if there are surface height variations in the work piece and regardless of focus tube 14 angle to the work piece.

Prior to beginning a cutting operation, the water jet cutting system 10 can undergo a calibration operation to establish several parameters or dimensions to be used during the cutting operation. Any suitable calibration is acceptable, and can be automatic or manual. The following few paragraphs outline one exemplary calibration operation, however, this is not intended to be a limiting method for calibration.

The first step in the exemplary calibration operation is to define the plane of the surface of the work piece 18. To start the cutting process, the height controller and the CNC 21 lower the bevel head and the focus tube 14 until contact is made with a work piece 18 in three different places on the surface of the work piece 18. Each time the focus tube 14 contacts the work piece 18, a signal is sent from the voltage feedback card to the CNC 21 to indicate the position of the work piece 18. The CNC 21 uses the three signals to calculate the planar surface of the work piece 18. In alternate embodiments, any means for detecting the surface of the work piece 18 three times to calculate the planar surface may be used without departing from the scope of the invention. At this point, the CNC 21 now “knows” where the plane of the top surface of the work piece 18 is located relative to the bevel head.

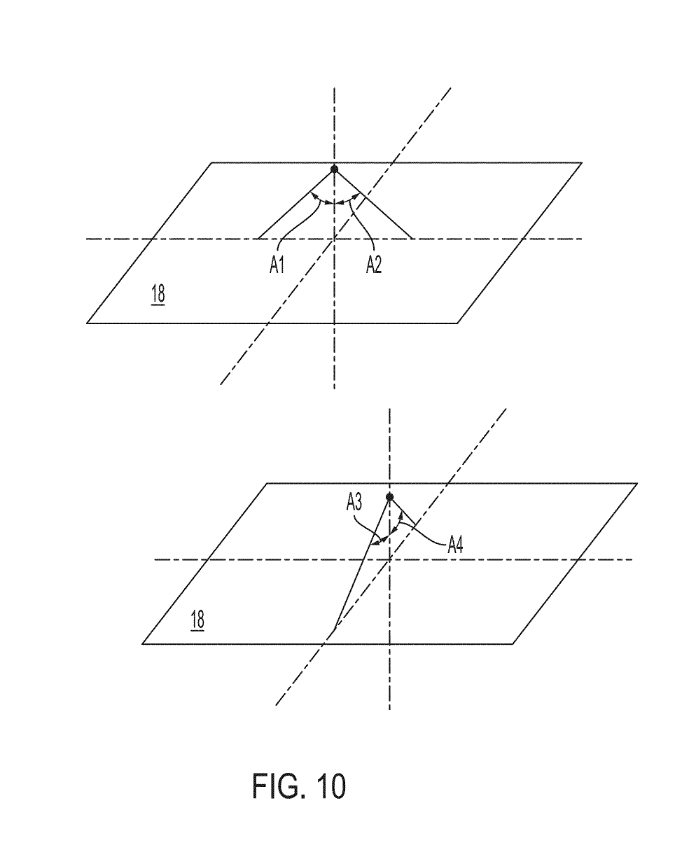

The second step in the exemplary calibration operation is to move the focus tube 14 to a position perpendicular to the surface of the work piece 18. The remainder of this paragraph describes the first of two steps to calibrate the focus tube 14 location along a first axis, such as the X-axis. The next paragraph describes the second of two steps to calibrate the focus tube 14 location along an axis perpendicular to the first axis, such as the Y-axis. Initially, the focus tube 14 is place in a substantially perpendicular orientation to the plane of the work piece 18. As shown in FIG. 10, the bevel head and focus tube 14 are lowered with the z-axis motor until contact with the work piece 18 is detected by a known means such as be reading the current limit on the servomotor. The focus tube 14 is then raised a determined height above the work piece 18. The focus tube 14 is then rotated relative the work piece a first specified angle A1 by rotating the first rotary drive 42 with the first servomotor. The first angle A1 can be between about 20 and about 60 degrees from vertical. In one embodiment, the first rotary drive 42 rotates the focus tube 14 a first angle A1 of 45 degrees. The focus tube 14 is then lowered with the z-axis motor 34 until contact with the work piece 18 is detected. After contact is made, the focus tube 14 is raised and rotated back through vertical to a second specified angle A2 relative the work piece by rotating the first rotary drive 42 with the first servomotor 60. The second angle A2 is desirably between about 20 and about 60 degrees from vertical in the opposite direction from the first angle A1. In one embodiment, the second angle A2 has the same magnitude as the first angle A1 but is in the opposite direction. With the focus tube 14 positioned at the second angle A2, it is lowered until contact with the work piece 18 is detected. The focus tube 14 is then raised and rotated back to a substantially vertical condition.

Next, the focus tube is rotated relative to the work piece 18 at a third specified angle A3 by rotating the second rotary drive 46 with the second servomotor 62. The focus tube 14 is moved in a plane to the third angle A3 that is orthogonal to the plane in which the focus tube 14 was moved when positioning at the first and second angles A1 and A2. The third angle A3 is desirably between about 20 and about 60 degrees from vertical. In one embodiment, the second rotary drive 42 rotates the focus tube 14 a third angle A3 of 45 degrees. The bevel head and the focus tube 14 are then lowered with the z-axis motor 34 until contact with the work piece 18 is detected. After contact is made, the focus tube 14 is raised and rotated back through vertical to a fourth specified angle A4 relative the work piece by rotating the second rotary drive 46 with the second servomotor 62. The fourth angle A4 is desirably between about 20 and about 60 degrees from vertical in the opposite direction from the third angle A3. In one embodiment, the fourth angle A4 has the same magnitude as the third angle A3, but is in the opposite direction. With the focus tube 14 positioned at the fourth angle A4, it is lowered until contact with the work piece 18 is detected. The CNC 21 can then direct the servomotors to locate the focus tube 14 in a position perpendicular to the work piece 18 based upon the information obtained from the four-touch process from angles A1, A2, A3, and A4.

The third step of the exemplary calibration operation is to establish the distance between the work piece 18 and the tip of the focus tube 14. This can be accomplished by placing one or more gauge blocks of known dimensions between the top surface of the work piece 18 and the focus tube 14. An operator can place the water jet cutting system 10 into a “jog mode” and slowly move the focus tube 14 toward the top surface of the work piece 18 until it touches a gauge block or very nearly touches a gauge block. Because the gauge blocks are of known dimensions, the operator can then input the distance of the tip 52 of the focus tube 14 from the work piece 18, and the water jet cutting system 10 is then calibrated for standoff height, and can reference that height for all future standoff height measurements for the particular cutting operation.

The fourth step of the exemplary calibration process determines the distance between the tip 52 of the focus tube 14 and the intersection point P of the axis X1 through the center of the focus tube 14 and the axis X2 extending from the center of the second rotary drive 46. The bevel head and focus tube 14 are rotated to a specified, known angle. The Z-axis servomotor then moves the bevel head and the focus tube 14 downward until contact is made with the work piece 18. At contact, the focus tube 14 can be considered to be representing one leg of a triangle. Another leg of the triangle is the focus tube 14 in the perpendicular orientation to the work piece 18. Because the CNC 21 “knows” the length of the two legs of a triangle described above, and the angle at which the non-perpendicular leg of the triangle is located in comparison to the perpendicular leg, the CNC 21 can then calculate the distance between the tip 52 of the focus tube 14 and the intersection point P of the axis X1 through the center of the focus tube 14 and the axis X2 extending from the center of the second rotary drive 46. This distance is used in the CNC 21 to accurately control the position and angle of the bevel head and the focus tube 14 during cutting operations.

To start the cutting process, the CNC 21 directs a verification of standoff height process to determine the standoff height. One example of a standoff height verification process can include a laser beam distance detection process to determine the distance between the focus tube 14 and the work piece 18. However, the laser beam is often not accurate due to water accumulation on the work piece 18, and substances such as garnet suspended in the cutting fluid inhibit an accurate reading. Another standoff height verification process can include a three-touch process. In the three-touch process, the probe head 50 is lowered until contact is made with the work piece 18 three times in three different places on the surface of the work piece 18. Each time the probe head 50 contacts the work piece 18, a signal is sent from the feedback card to the CNC 21 to indicate the position of the work piece 18. The CNC 21 uses the three signals to calculate the planar surface of the work piece 18. In other examples, any means for detecting the surface of the work piece 18 three times to calculate the planar surface may be used without departing from the scope of the disclosure. After the surface of the work piece 18 has been determined, the focus tube 14 is moved to an appropriate standoff height as determined by the CNC 21. A signal is sent from the feedback card to the CNC 21 allowing the CNC 21 to control the motion of the focus tube 14 and the bevel head 40.

Turning to FIG. 4, the CNC 21 can include application software 78. The application software 78 can be used to convert various design files into machine code. The design files can include, but are not limited to files designated as “.dxf” files. The machine code is then used to control the positioning apparatus 16 to move the focus tube 14 in relation to the work piece 18 to make cuts within the work piece 18 as they are described within a particular design file.

In another example, the water jet material cutting system 10 can be used to cut shapes within the work piece 18 having a kerf edge that is formed at a particular angle to the surface of the work piece 18. In one example of application programming, the shape or hole can have a particular desired angle of kerf. Rather than an operator trying to correct for the angle of kerf through trial-and-error, a desired cut angle can be used by the bevel head to adjust for the cut taper. For example, a piece of steel of particular thickness can be cut at a particular cut speed to result in a known cut taper, in degrees. These values can be obtained prior to a cutting job such that the operator can read a table of variables to program the application to cut the shape or hole at a particular angle to develop the desired cut taper. These values can be placed in an application table based on experience of the operator or others, downloaded from a known source, or even built up individually during a particular job. At that point, the application software 78 references the table embedded within the application software 78 to calculate, determine, or find the proper angle 76 of the focus tube 14 to produce the desired kerf edge angle and automatically cut the shape or hole. The resultant shape or hole will then have a kerf edge that is perpendicular (or any other suitable desired angle) to the planar surface of the work piece 18 for the particular thickness of the work piece without any further information supplied by the operator.

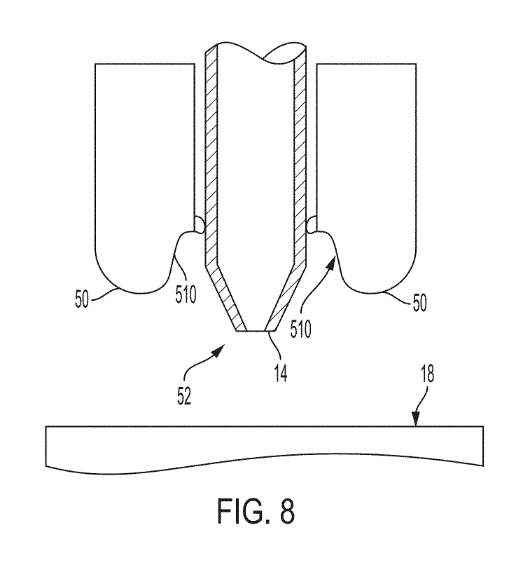

Turning to FIG. 8, the probe head 50 can include a concave surface 510. This concave surface 510 can limit the amount of cutting fluid that splashes back away from the top surface of the work piece 18, particularly during a piercing operation. An amount of the probe head 50 can be sculpted away to form any suitable shape of the concave surface 512 that will limit and/or eliminate the “splash back” of cutting fluid to undesired locations. In one example, a seal can be placed between the focus tube 14 and the probe head 50 to reduce and/or eliminate undesired material from entering the annular space between the focus tube 14 and the probe head 50.

As noted in the Description of Related Art section above, water jet material cutting systems sometimes include verification of standoff height, however, many work piece contact devices are located at a relatively long distance from the focus tube. In these examples, the longer distance between the contact devices and the focus tube decreases the accuracy of the measurement. Additionally, the contact device of these other systems has even less accuracy during many bevel cutting operations because the angle of the bevel head will even further increase the distance of the contact device to the work piece.

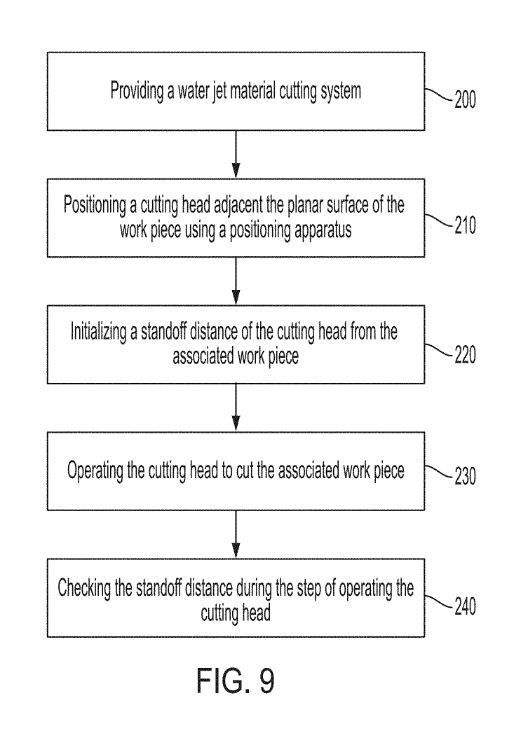

Turning to FIG. 9, a method of operating a water jet material cutting system including a computerized numeric controller will now be described. The method includes the step 200 of providing the water jet material cutting system as is described above. The cutting system includes a table configured to receive the associated work piece, a bevel head including a focus tube, a positioning apparatus, a CNC controller, and a height sensor. The method also includes the step 210 of positioning the bevel head adjacent the planar surface of an associated work piece using a positioning apparatus.

The method further includes the step 220 of initializing a standoff height or standoff height of the bevel head from the associated work piece by any suitable method, including any of the ways described above. The method still further includes the step 230 of operating the bevel head to cut the associated work piece and finally, step 240 of checking the standoff height during the step of operating the bevel head.

In another example of the method, the focus tube includes a cutting axis 244. The cutting axis 244 can be interpreted as a line coincident with the central axis of the focus tube, and generally represents the path of the water jet as it leaves the focus tube 14. The probe head 50 is configured to move in a direction parallel to the cutting axis 244 as shown by the arrows 246 in FIG. 5. In another example, the method step of checking the standoff height includes periodically moving the probe head 50 during a cutting operation in order to check the standoff height. The CNC programming may include a periodic check of the standoff height by length of time cut, distance cut, or any other parameter.

In yet another example, the method can further include the step of modifying the standoff height of the bevel head to maintain a desired dimension of the desired cut pattern on the associated work piece based upon a change in the standoff height due to surface height variations in the associated work piece. In other words, as the height sensor detects a surface height variation in the work piece that affects the standoff height, such as a warped portion along the cut path, this information is provided to the CNC as described above. The CNC can then readily calculate how far to move the bevel head in the Z-axis to maintain the desired standoff height. This information is then sent to the head controller which can then adjust the height of the bevel head and the focus tube and thus adjust the standoff height to maintain the desired cut line.

As an example of the method and the apparatus, a work piece to be cut is placed on a table of the water jet material cutting system, and at least a portion of the work piece has a planar surface facing away from the table. The bevel head and the focus tube are then positioned adjacent the planar surface of the work piece using a positioning apparatus. As previously described, the height of the focus tube can be calibrated relative the work piece with the work piece on the table by using the height sensor. Additionally, location information provided by the encoder and voltage information provided by the voltage feedback card, in conjunction with a desired work piece cut path programmed into the CNC, provide an input signal to the positioning apparatus to change the standoff between the focus tube and the work piece.

It is to be understood that the angle can be “locked in” to retain the same angle 76 relative to a particular reference. For example, if the focus tube is cutting a hole from the work piece, the focus tube can pierce the hole inside the desired cut pattern, tilt to the calculated angle from the perpendicular and “lock in” the angle, complete the lead-in, traverse the desired cut pattern, and then traverse the lead-out to finish the hole-cutting operation. The “locked in” angle, for the purposes of this disclosure, means the components of the positioning apparatus orients the focus tube at an angle relative to a center axis of the hole. As such, the positioning apparatus continuously adjusts the focus tube orientation as the focus tube moves about the desired cut pattern in order to maintain the same kerf edge angle relative to the center axis of the hole.

The work piece 18 can be cut with a particular progression of steps. In one example, the application software converts a particular design file into machine code. The machine code is then used to control the positioning apparatus 16 to move the focus tube 14 in relation to the work piece 18 to make cuts within the work piece 18 as they are described within the particular design file. The application software can also include an embedded table of values 80 (best seen in FIG. 4). The table of values 80 can include any number of variables relating to the work piece 18. The CNC 21 retrieves values or variables from the table of values 80 and determines the best operation parameters for the particular work piece material, cut shape, environmental parameters, etc. The focus tube 14 can then cut a lead-in path, the desired shape, and a lead-out path prior to turning off the water jet.

While the disclosure has been illustrated and described in typical exemplary embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A water jet material cutting system for cutting a work piece comprising:
a table for receiving said work piece;
a bevel head operatively connected to said table, said bevel head having a cutting device for cutting said work piece;
a positioning apparatus attached to said bevel head for adjusting a position and an orientation of said bevel head with respect to said work piece, wherein said positioning apparatus moves said bevel head relative to said work piece;
a controller operatively connected to said positioning apparatus, wherein said controller controls said positioning apparatus; and
a height sensor attached to said positioning apparatus, said height sensor determine a standoff height between said bevel head and said associated work piece;
wherein said positioning apparatus adjusts said position and/or said orientation of said bevel head relative to said work piece in response to said standoff height.

2. The water jet material cutting system of claim 1, wherein the height sensor is located proximal to the bevel head.

3. The water jet material cutting system of claim 1, wherein the bevel head further comprises a focus tube, and the height sensor comprises a probe head having an annular shape that surrounds the focus tube.

4. The water jet material cutting system of claim 1, wherein the probe head includes a surface having a known radius and the surface faces the work piece.

5. The water jet material cutting system of claim 1, wherein the bevel head further comprises a focus tube for a water jet, the focus tube having a cutting axis and the probe head is configured to move in a direction parallel to the cutting axis.

6. The water jet material cutting system of claim 5, wherein the probe head moves along the outside of the focus tube in a direction parallel to the cutting axis.

7. The water jet material cutting system of claim 1, wherein the positioning apparatus is configured to position the bevel head according to a perimeter of a desired cut pattern in order to cut a section of the work piece.

8. The water jet material cutting system of claim 7, wherein the positioning apparatus position the focus tube on the bevel head at an angle relative to a surface of the work piece such that the focus tube is held at an angle relative to a perpendicular orientation with respect to an upper surface of the work piece and the controller controls the position of the focus tube at the angle relative to the perpendicular orientation of the upper surface of the work piece.

9. The water jet material cutting system of claim 1, wherein a position of the probe head is accessible by the controller in order to modify a perimeter of a desired cut pattern of the bevel head to maintain a desired dimension of the desired cut pattern on the work piece based upon a change in the standoff height due to an irregularity in the associated work piece.

10. A method of operating a water jet material cutting system including a computerized numeric controller, wherein the method comprises:
providing a water jet material cutting system comprising:
a table configured to receive an associated work piece;
a bevel head including a focus tube configured to provide a water jet to a location to cut the associated work piece on the table;
a positioning apparatus attached to the bevel head for controlling the position and orientation of the bevel head with respect to the associated work piece on the table, wherein the positioning apparatus moves the bevel head relative to the associated work piece;
a computerized numeric controller including an application software program, wherein the computerized numeric controller controls the positioning apparatus; and
a height sensor attached to the positioning apparatus configured to determine a stand-off height of the bevel head from the associated work piece,
positioning a bevel head adjacent the planar surface of the work piece using a positioning apparatus;
initializing a standoff height of the bevel head from the associated work piece;
operating the bevel head to cut the associated work piece;
checking the standoff height while operating the bevel head.

11. The method of operating a water jet material cutting system according to claim 10, wherein the focus tube includes a cutting axis and the probe head is configured to move in a direction parallel to the cutting axis.

12. The method of operating a water jet material cutting system according to claim 11, wherein the probe head moves along the outside of the focus tube in a direction parallel to the cutting axis.

13. The method of operating a water jet material cutting system according to claim 11, wherein the step of checking the standoff height includes periodically moving the probe head to contact the surface of the work piece during a cutting operation in order to check the standoff height.

14. The method of operating a water jet material cutting system of claim 11, further including the step of moving the bevel head along the Z-axis to maintain a constant standoff height from the associated work piece taking into account surface height variations in the associated work piece in both perpendicular and non-perpendicular orientations.

15. The method of operating a water jet material cutting system of claim 10, wherein the step of checking the standoff height can happen when the focus tube is perpendicular to the associated work piece.

16. The method of operating a water jet material cutting system of claim 10, wherein the step of checking the standoff height can happen when the focus tube is not perpendicular to the associated work piece.

17. A method of operating a water jet material cutting system comprising using a positioning system having five degrees of freedom to control the position and inclination of the focus tube, the method comprising:
placing a work piece to be cut on a table of the water jet cutting system, wherein at least a portion of the work piece has a planar surface facing away from the table; and
positioning a focus tube adjacent the planar surface of the work piece using a positioning apparatus, wherein the positioning apparatus has at least five degrees of freedom about which it can move the focus tube relative the work piece for cutting the work piece on the table.

18. The method of operating the water jet material cutting system of claim 17, further comprising calculating the planar surface of the work piece by contacting the work piece with the focus tube at least three times.

19. The method of operating the water jet material cutting system of claim 18, wherein the each time the focus tube contacts the work piece, a signal is sent from the voltage feedback card to the CNC to indicate the position of the work piece.

20. The method of operating the water jet material cutting system of claim 18, further comprising calibrating the cutting system by calculating the distance between the tip of the focus tube and the intersection point P of an axis through the center of the focus tube and an axis extending from the center of the second rotary drive.
